(19) United States
(12) Patent Application Publication
(10) Pub. No.: US 2025/0362755 A1
(43) Pub. Date: Nov. 27, 2025

(54) DEVICES AND METHODS FOR REMOTE GESTURE CONTROL OF ELECTRONIC DEVICES

(71) Applicant: Gergely Márton, Budapest (HU)

(72) Inventors: Gergely Márton, Budapest (HU); Zsófia Flóra Török, Budaörs (HU)

(21) Appl. No.: 19/215,222

(22) Filed: May 21, 2025

Related U.S. Application Data
(60) Provisional application No. 63/649,974, filed on May 21, 2024.

(51) Int. Cl. G06F 3/01; G04G 21/00

(52) U.S. Cl. CPC G06F 3/017; G04G 21/00

(57) ABSTRACT

A device for generating gesture commands based on the fused inertial data of at least a first and a second motion sensor, located, respectively, distally and proximally in relation to the wrist joint when mounted on a user's wrist. Methods for the utilization of such a device.

### FIELD

The present invention relates to the field of wearable devices and methods related to them, more particularly devices and methods for the remote gesture control of electronic devices.

### BACKGROUND

As people interact with more and more electronic devices in their everyday lives, there is a growing need for efficient and intuitive interfaces that are capable of making the control of these devices as convenient and easy as a flick of the wrist. The existing interfaces for such devices include the mouse, remote control, keyboard, touch screen, and so on. Technology has surpassed these tools: we need a faster, smaller, subtler solution to interact with our machines that allows at least a similar scope of input to the previously listed devices.

Most of the existing wearable control devices use cameras, infrared, sonography, or other additional sensing, such as electromyography, which is difficult to measure around the wrist, besides the, usually one, inertial measurement unit, to be able to correctly recognize the movement of the wearer's hand. These features usually make the devices bulky with low battery life and unusable in certain environments.

Another approach is based on glove-like devices which contain several sensors to be placed on the hand and the fingers. These devices have failed to provide an actual solution for the above described challenges, as they are cumbersome and uncomfortable to use. Furthermore, these sorts of devices that are significantly more expensive to produce than the one herein described, have an unnatural and unaesthetic look when worn by users that adds to the low user acceptance.

There is a clear need for a simple, easy to use, convenient and sleek wearable device that allows the remote control of the many electronic devices around us. The present invention is aimed at exploiting the structure and mechanics of the human wrist and hand by utilizing sensor fusion, which enables the wrist-worn device for the remote gesture control of electronic devices herein described to be sleek, comfortable to wear, and to provide a high level of accuracy in its gesture recognition. It facilitates gesture control, moving only the hand and not the whole forearm to control electronic devices, unlike with other motion sensor based interfaces.

### SUMMARY

In one aspect, the disclosed invention provides a wrist-worn device for the remote gesture control of electronic devices which is, to surpass the limitations of existing human-machine interfaces, configured to exploit the natural structure and mechanisms of the human hand and wrist by affixing a motion sensor (in most embodiments, inertial measurement unit) to the distal and another motion sensor to the proximal side of the wrist joint of a user. In some embodiments a third motion sensor is affixed above the thumb extensor tendon (EPL). By translating the fused motion data, provided by the first, second and, in some embodiments, a third inertial measurement unit, into gesture commands, the device provides control commands for electronic devices wirelessly connected to it.

In another aspect, the present invention provides a method for the remote gesture control of electronic devices using a wrist-worn device comprising mounting the device on a wrist of a user in such a way that a first motion sensor is affixed to the proximal and a second motion sensor is affixed to the distal side of the same wrist joint of the user; wherein the device or connected computing device facilitates the identification of gesture commands, based on the fused motion data generated by the motion sensors, that are communicated to the electronic devices wirelessly connected to the device, as control commands.

### BRIEF DESCRIPTION OF THE DRAWINGS

FIG. 1a schematically illustrates an embodiment of the wrist worn device (101) in use, wirelessly transmitting signals to a controlled electronic device (107), which is in the depicted case, a laptop.

FIG. 1b schematically illustrates an embodiment of the present invention, wherein the wrist mounted device (101) wirelessly transmits data to a connected computing device (108) on which the gesture recognition software component is run, generating control commands from the inertial data. These control commands are then wirelessly transmitted to a controlled electronic device (107), depicted here as a smart television for illustrative purposes, for immediate response.

FIG. 1c schematically depicts an embodiment of the disclosed invention further comprising a main body (109) carried by the first strand (105), containing at least the first motion sensor (103) and main electronic components (110) of the device.

FIG. 2 illustrates the proximal side (201), the distal side (202), the dorsal side (203) and the volar side (204) of a wrist joint as referred to in the present disclosure.

FIG. 3 illustrates examples of gestures (301) that may be set as gesture commands for the device, or software component, to identify. As a result of the novel and unique configuration of the device regarding sensor placement, it is sufficient to move the hand from the wrist and not the whole forearm.

FIG. 4 depicts the mechanism of an embodiment of the disclosed invention in a block diagram.

FIG. 5 illustrates schematically a motion sensor, more specifically an inertial measurement unit that in this example comprises an accelerometer (501), a gyroscope (502) and a magnetometer (503).

FIG. 6a schematically illustrates an embodiment of the disclosed wrist worn device that further comprises a third motion sensor (601) located on the section of the first strand (105) falling closest to the thumb extensor tendon (EPL) (602), further enhancing the amount and subtlety of gestures that the device facilitates the recognition of.

FIG. 6b illustrates the thumb extensor tendon (EPL) (602).

FIG. 7a schematically illustrates an embodiment of the disclosed invention that allows the insertion of a smartwatch device (701) in place of the first motion sensor; wherein the smartwatch's internal IMU replaces the first motion sensor and generates a first inertial data. The illustrated embodiment further comprises a third motion sensor (601) located on the section of the first strand (105) falling closest to the thumb extensor tendon (EPL) (602). In some versions of this embodiment, the processing of the inertial data and gesture recognition happens on the inserted smartwatch, which performs also the real-time transmission of the control commands to an electronic device for immediate response.

FIG. 7b schematically illustrates an embodiment of the disclosed invention that allows the insertion of a smartwatch device (701) in place of the first motion sensor; wherein the smartwatch's internal IMU replaces the first motion sensor and generates a first inertial data. In some versions of this embodiment, the processing of the inertial data and gesture recognition happens on the inserted smartwatch, which performs also the real-time transmission of the control commands to an electronic device for immediate response.

FIG. 8 schematically illustrates three possible versions of an embodiment of the disclosed invention that is an accessory for a smartwatch for facilitating hand gesture recognition. The first version depicts the auxiliary motion sensor (801) being attached to the smartwatch (701) by a flexible cantilever (802). The second drawing depicts a second version, wherein the auxiliary motion sensor (801) is attached to the smartwatch (701) via a strap (803). The third drawing depicts a version of the smartwatch accessory, wherein the auxiliary motion sensor (801) is attached to the smartwatch (701) by adhesive material (804).

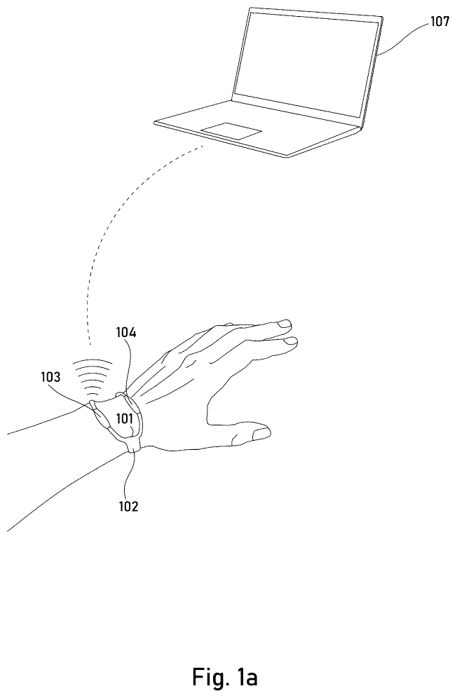

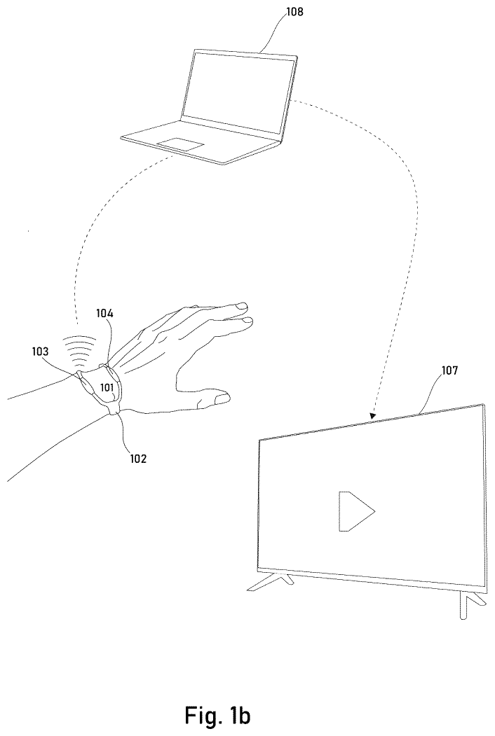

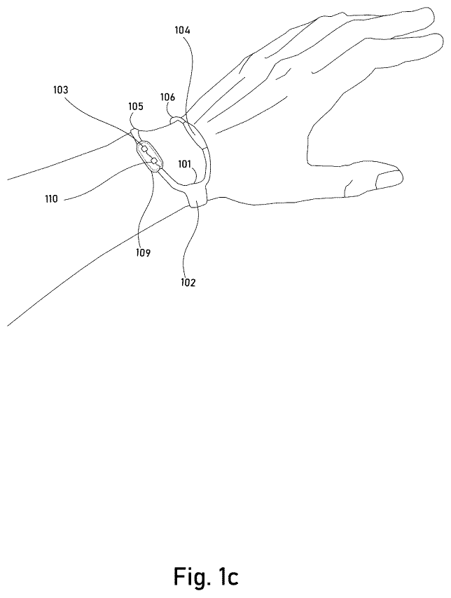

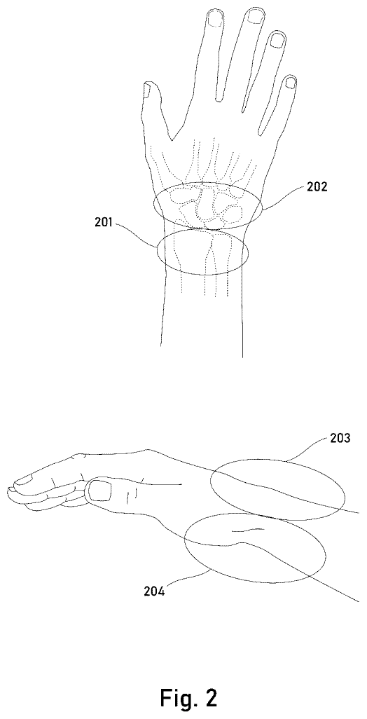

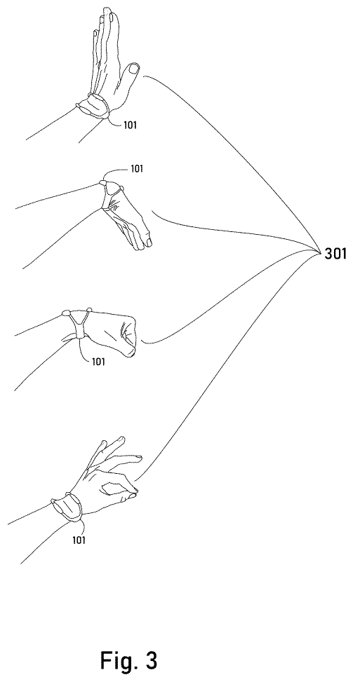

### DETAILED DESCRIPTION

A first embodiment of the wireless, wrist worn device (101) for the remote gesture control of electronic devices comprises at least a wrist mountable strap (102); a first motion sensor (103), carried by the wrist mountable strap, configured to sit on the proximal side of the wrist joint (201), or more conversationally, on the top section of the forearm; a second motion sensor (104) carried by the wrist mountable strap, configured to sit on the distal side of the same wrist joint (202), for example on the base of the back of the hand of a user.

By translating the fused inertial data (406), provided by the first, second and, in some embodiments, a third motion sensor (601), into gesture commands (407), the device (101), or a connected computing device (108), provides control commands for electronic devices wirelessly connected to the device.

The wrist mountable strap (102) may be of a sleek elastic fabric, rubber, nylon, leather, silicone, woven fabric or any sort of material that is capable of holding the motion sensors' intended placements on the user's wrist and hand during movement and is elastic enough to ensure the user's comfort. In some embodiments the strap is adjustable to accommodate different wrist circumferences. In most embodiments, the strap splits into two strands on the section that sit on the dorsal, (top), side of the wrist and hand, which strands unite at the volar (under/palmar) side of the wrist; however, the device herein described is not limited to such embodiments, all possible configuration of the invention falls under the scope of the present disclosure, which is defined by the claims.

The motion sensors (103, 104, 601) are, in some embodiments, inertial measurement units (IMUs). Each IMUs can comprise an accelerometer (501) that generates acceleration data; a gyroscope (502), generating angular velocity data; and a magnetometer (503) generating orientation data. Each IMU can contain a combination of these measurement modalities, and these modalities can be measured along various number of axes (typically, 3 axes each). The data generated by an IMU is collectively referred to as inertial data (504) for the purposes of the present disclosure. Once the device is mounted on a user's wrist, as intended, the first motion sensor is configured to be affixed to the proximal side of the wrist (201), more specifically on the section of the forearm closest to the user's wrist. The first motion sensor (103) generates inertial data (first inertial data) (402) representative of the movement and orientation of the section of the forearm closest to the wrist. Whereas, when mounted, the second motion sensor (104) is configured to sit on the distal side of the user's same wrist (202), more specifically the base of the back of the hand and generates inertial data (second inertial data) (403) representative of the orientation and movement of this section of the user's body.

The main electronic components (110) of the device can contain battery, power management circuitry, wireless module. The main electronic components (110) of the device can be connected to the first motion sensor (103) and the second motion sensor (104) via conductive wires.

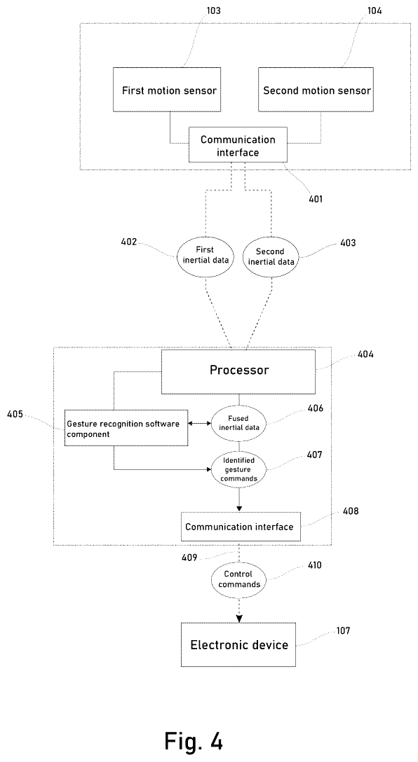

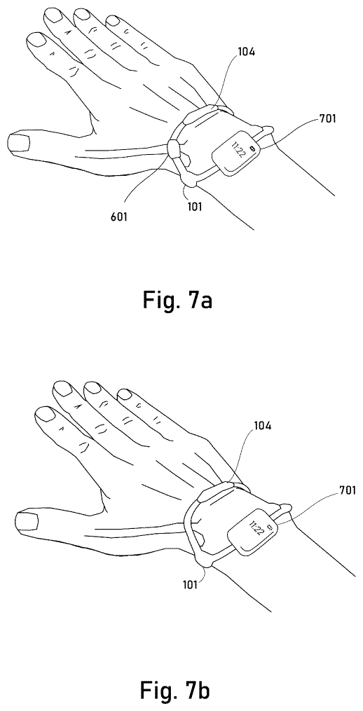

FIG. 4 depicts the mechanism of an embodiment of the disclosed invention in a block diagram. The depicted embodiment is such that the device transmits the raw first and second inertial data, generated by the first motion sensor (103) and the second motion sensor (104), via a communication interface (401) to a connected computing device, wherein the gesture recognition software component (405) is run by the processor (404) of the connected computing device that combines the inertial data of the first and second motion sensors into fused inertial data, and from the fused inertial data (406) it identifies gesture commands (407), which are then wirelessly transmitted (409) by the communication interface (408) of the connected computing device, as control commands (410) to the controlled electronic device (107) for immediate response. In some embodiments the connected computing device may be replaced by an inserted smartwatch device (701), as depicted in FIG. 7a and FIG. 7b.

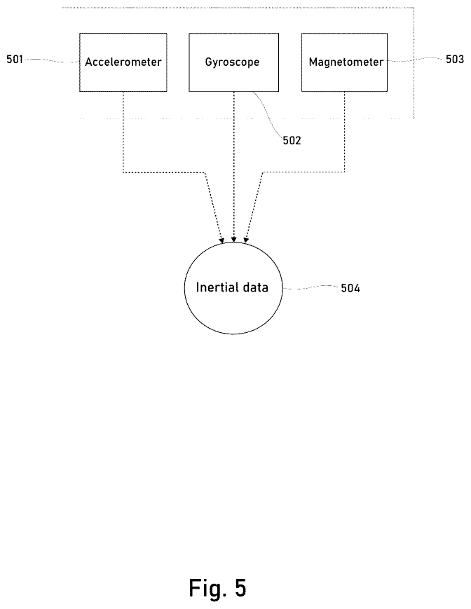

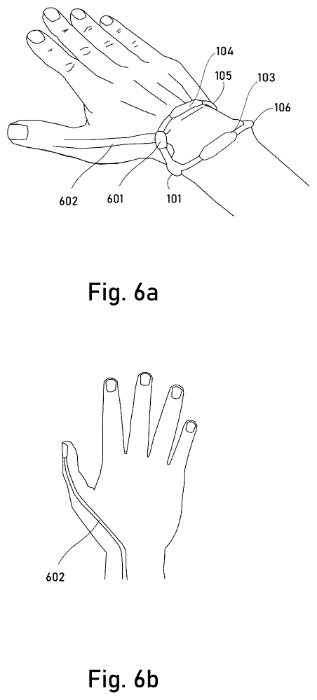

FIG. 5 illustrates schematically a motion sensor, more specifically an inertial measurement unit that in this example comprises an accelerometer (501), a gyroscope (502) and a magnetometer (503). The data generated by an inertial measurement unit is collectively referred to as inertial data (504) for the purposes of the present disclosure.

As mentioned previously, in some embodiments the device comprises a processor (404) running a software component (gesture recognition algorithm) (405) that identifies specific gestures (301) made by the user while wearing the device. In some other embodiments the software component runs on a computing device (108) connected to the device (101) instead of on the device itself. The software component (405) fuses the first (401) and second inertial data (403), therefore facilitating improved gesture identification based on the relational qualities of the first and the second inertial data representing the movement and orientation of the proximal and distal sides of the wrist, respectively. The software component (405) transforms the identified gestures (407), if they correspond to specific preset gesture commands, into control commands (410) that are transmitted through a wireless communication protocol (409) by the communication interface of the device (401) or of the computing device (408) to a controlled electronic device (107) for immediate response. In some of the embodiments, the software component (gesture recognition algorithm) (405) runs on the electronic device (107) that is being controlled, therefore in these embodiments, the wrist worn device transmits the raw inertial data through a wireless communication protocol to the controlled electronic device (107), on which the software component runs that performs data fusion and gesture identification, outputting and executing a control command (410).

The controlled electronic device (107) may be any sort of responsive electronic device that is capable of receiving control commands wirelessly, or that may be configured to receive control commands wirelessly, such as, but not limited to, computers, laptops, televisions, mobile phones, smart home devices (lamps, automatic doors . . . ), vehicles, speakers, etc.

Connected computing devices (108) may be, but are not limited to mobile phones, computers, laptops, smartwatches, or any sort of devices or systems capable of running software components/gesture recognition algorithms.

The device herein described facilitates gesture control, moving only the hand and not the whole forearm to control electronic devices, which differentiates it from other, wrist worn human-machine interfaces. Furthermore, the disclosed device is capable of detecting precise wrist movements due to its configuration and the placement of the at least two motion sensors. One is located on the top of the arm (proximal side of the wrist), which experiences less movement due to its placement and another located closer to the back of the hand, experiencing more, subtler movements. The movements of the arm can be detected as the motions that are the same in both sensors and deducted from the movements of the hand, therefore generating a more precise and exact identification of wrist movements. This allows hand gestures to be detected clearly, even during the movement of the whole arm, or the forearm. Moreover, the movements of the forearm may be recognized as gestures as well and/or be combined with hand movements as additional input, or specification of certain gestures.

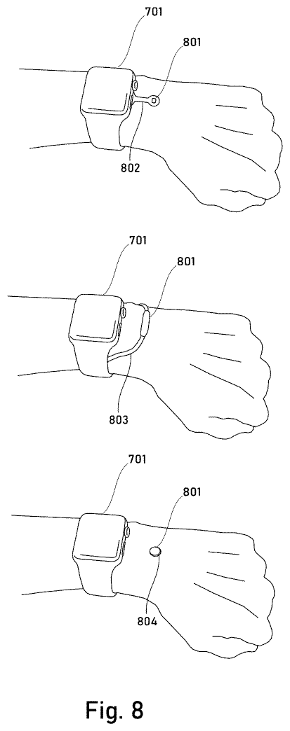

In some embodiments, the device is an accessory of a smartwatch (701) (FIG. 8.), comprising at least one auxiliary motion sensor (801), and at least one auxiliary motion sensor (801) is located on the same hand of the user as the smartwatch (701). At least one auxiliary motion sensor (801) of the accessory is located such that the auxiliary motion sensor (801) is anatomically more distal than the motion sensor of the smartwatch. The accessory can be connected to the smartwatch wirelessly, or the accessory and the smartwatch can be both connected to a computing device wirelessly, either directly or through intermediary electronic devices (e.g. wireless routers), or the accessory can be connected to the smartwatch with wires. The auxiliary motion sensor which is more distal than the motion sensor of the smartwatch can be configured to remain in place at a certain location of the hand of the user via an adhesive material (804) or via a strap (803) or via a flexible cantilever (802) which is mounted onto the smartwatch, or any other solution that is sufficient to hold the motion sensor in place. In these embodiments, an algorithm can be executed on the smartwatch, or on a computing device which is connected to both the smartwatch and the smartwatch accessory. The algorithm can utilize the data generated by both the smartwatch and the smartwatch accessory in order to determine the hand gestures of the user. A version of these embodiments may be a ring device comprising at least a motion sensor and a communication interface that serves as the accessory of a smartwatch device and sits on one of the fingers of the user, on the same hand on which the smartwatch device is worn.

1. A wearable device for remote gesture control of electronic devices comprising at least a first motion sensor for generating a first inertial data, the first motion sensor being configured to be affixed to a first body part of a user, which first body part is anatomically proximal relative to a wrist joint of an arm of the user, and which first body part is anatomically distal relative to an elbow join to of the said arm of the user, wherein the device further comprises a second motion sensor for generating a second inertial data, the second motion sensor configured to be affixed to a second body part of a user, which second body part is anatomically distal relative to the said wrist joint of the user, and wherein the device or a connected computing device facilitates identification of hand gesture commands by combining the first inertial data and the second inertial data.

2. A device according to claim 1, wherein the first motion sensor and the second motion sensor are placed on a wrist mountable strap, which wrist mountable strap is split into a first strand and a second strand, and the first strand and the second strand are connected at a side of the said wrist of the user which side is anatomically volar, and the first strand carries the first motion sensor and the second strand carries the second motion sensor.

3. A device according to claim 2, wherein the second strand runs along the distal side of the said wrist joint and on the proximal side of the metacarpophalangeal joint of a thumb of the user.

4. A device according to claim 2, wherein the device further comprises a main body, which main body contains main electronic components, and the main body also contains the first motion sensor, and the main body is located on the first strand, and the main body is configured to be affixed to the first body part when mounted on the wrist of the user.

5. A device according to claim 2, wherein the device further comprises a third motion sensor, located on a section of the first strand which section of the first strand is located at a maximum 2 centimeter distance from the thumb extensor tendon (EPL) when mounted on the wrist of a user, and wherein the third motion sensor generates a third inertial data.

6. A device according to claim 4, wherein the device further comprises:
a processor, which processor fuses the first inertial data and the second inertial data and which processor employs gesture recognition algorithms to classify gestures based on predefined patterns associated with gesture commands;
a communication interface, which communication interface facilitates real-time transmission of the gesture commands to an electronic device for immediate response.

7. A device according to claim 5, wherein the device further comprises:
a processor, which processor fuses the first, second and third inertial data and employs gesture recognition algorithms to classify gestures based on predefined patterns associated with gesture commands;
a communication interface, which communication interface facilitates real-time transmission of the gesture commands to an electronic device for immediate response.

8. A device according to claim 2, wherein the device further comprises a communication interface, which communication interface facilitates real-time transmission of the first inertial data and the second inertial data to a controlled electronic device.

9. A device according to claim 1, wherein the first motion sensor is contained by a smartwatch, and the second motion sensor is connected galvanically or via a wireless connection to the smartwatch.

10. A wrist worn device for remote gesture control of electronic devices according to claim 9, wherein the device contains a third motion sensor, and the third motion sensor is connected galvanically or via a wireless connection to the smartwatch.

11. A method for facilitating hand gesture recognition comprising:
affixing a first motion sensor into a proximal side of a user's wrist and a second motion sensor to a distal side of the user's wrist;
wherein the first motion sensor generates a first inertial data and the second motion sensor generates a second inertial data;
wherein the relational qualities of the first and second inertial data facilitate the precise identification of wrist movements of the user, from which performed hand gestures may be inferred.

12. A method facilitating hand gesture recognition, according to claim 11, for remotely controlling an electronic device with gesture commands using a wrist worn device comprising:
mounting the wrist worn device on the user's wrist in a way that a first motion sensor is affixed to the proximal side, and a second motion sensor is affixed to the distal side of a wrist joint of a user;
collecting inertial data (movement and orientation) from the first and the second motion sensor;
wherein the wrist worn device facilitates the identification of gesture commands based on the fusion of the inertial data generated by the first and the second motion sensor;
wirelessly transmitting control commands by a communication interface to the electronic device;
wherein the control commands are generated from the gesture commands identified by the wrist worn device or a connected computing device, and are configured to prompt a response by the electronic device.

13. A method according to claim 10, wherein the wrist worn device further comprises a third motion sensor which is affixed at a maximum 2 centimeter distance from the thumb extensor tendon (EPL) of a user's hand, and wherein the device facilitates the identification of gesture commands based on the fusion of the inertial data generated by the first, second and third motion sensor.

14. A method according to claim 10, wherein the first motion sensor is contained by a smartwatch.

15. A method for remotely controlling an electronic device with gesture commands using a wrist worn device according to claim 12,
wherein the wrist worn device is configured in a way that allows the insertion of a smartwatch device in place of the first motion sensor;
wherein the device facilitates the identification of gesture commands based on the fusion of the inertial data generated by the smartwatch's internal IMU, the second and third motion sensor.

16. A hand gesture detector system comprising a smartwatch and an accessory for a smartwatch, wherein the accessory comprises at least an auxiliary motion sensor affixed to a distal side of a wrist of a user, and wherein an internal motion sensor contained by the smartwatch generates a first inertial data and the auxiliary motion sensor generates a second inertial data, and relational qualities of the first and second inertial data facilitate identification of wrist movements, from which performed hand gestures are inferred.
